(19) United States
(12) Patent Application Publication
(10) Pub. No.: US 2011/0246016 A1
(43) Pub. Date: Oct. 6, 2011

(54) METHOD OF DISPLAYING TRAFFIC INFORMATION

(75) Inventors: Doua Vang, Waterford, MI (US); Bilal Alasry, Dearborn, MI (US)

(73) Assignees: DENSO INTERNATIONAL AMERICA, INC., Southfield, MI (US); DENSO CORPORATION, Kariya-Shi (JP)

(21) Appl. No.: 12/751,880

(22) Filed: Mar. 31, 2010

(51) Int. Cl. G08G 1/00; G06F 17/30; G06F 15/16

(52) U.S. Cl. 701/29; 707/705; 709/219; 707/E17.014

(57) ABSTRACT

A method of displaying traffic on a display within a vehicle may include monitoring a current vehicle speed, monitoring external traffic data by various methods, determining if a brake is applied for at least a predetermined time period, determining if the vehicle is a predetermined distance from a traffic signal that the vehicle is approaching, determining that a traffic event exists on a road upon which the vehicle is traveling, inquiring if traffic cameras exist on the road upon which the vehicle is traveling, and displaying traffic data on a display within the vehicle that corresponds to the road ahead upon which the vehicle is traveling. The method may include determining if the vehicle speed is maintained at a speed less than the posted speed for a predetermined time period. The display may display traffic data captured by the traffic cameras, downloaded from remote servers, or communicated directly from another vehicle.

### FIELD

The present disclosure relates to a method of controlling a navigation system.

### BACKGROUND

This section provides background information related to the present disclosure which is not necessarily prior art. Modern vehicles may be equipped with a navigation system such as a built-in, factory installed navigation system or an after-market navigation system that is portable and may be easily installed and removed from an interior surface of a vehicle windshield. Such vehicle navigation systems may be capable of displaying real-time traffic camera feeds from roadways in front of or surrounding the vehicle. Selection of a specific camera feed may be made by selecting an icon from the navigation system display. While such navigation display traffic camera feeds have been satisfactory for their purposes, such systems are not without their share of limitations. One limitation relates to the number of icons that may be readable upon being displayed upon a navigation system display. More specifically, if a driver is driving in a densely populated urban area, such as a city, such city may have traffic camera feeds available for nearly every traffic light in the city. Selecting any given traffic camera feed from the navigation system display may mean selecting an icon on the navigation system display, which may be very crowded with not only traffic camera feed icons, but other icons such as “point of interest” icons, “building” icons, etc. What is needed then is a system or method for selectively displaying traffic camera feed icons on a navigation system display to avoid overcrowding the navigation system display with icons.

### SUMMARY

This section provides a general summary of the disclosure, and is not a comprehensive disclosure of its full scope or all of its features. Method steps provided may be performed in the order presented or in an order deviating from that presented. A method of displaying traffic of a road on a display within a vehicle may include monitoring a current speed of a vehicle and monitoring external traffic data. Moreover, the method may include monitoring a brake of a vehicle, determining that the brake of the vehicle has not been applied for at least a predetermined time period, monitoring the speed of a vehicle, and determining if there is any external traffic information regarding the road upon which the vehicle is traveling. External traffic information may come from a variety of sources, such as a commercial traffic information source such as XM traffic, live camera feeds from traffic cameras located along roads, and computer servers that record traffic information from camera feeds. Determining if there is any external traffic information may involve vehicle to vehicle verification or communication or vehicle to computer server before actually attempting a download or displaying of such information.

Moreover, the method may entail determining that traffic cameras exist ahead on the road, and displaying, on the display, camera images that the traffic cameras view. The display, such as a navigation system display, may also display traffic video images from a computer server located away from the vehicle or may entail communicating with another vehicle using direct vehicle to vehicle communication. That is, one vehicle may relay its traffic video information to another vehicle.

Still yet, a driver speed database may be stored in a controller memory within the vehicle and may be used in determining that the vehicle driver commonly or repeatedly drives more slowly relative to posted speed limits for a given road. Thus historical driving habits for a given driver may be recorded within such a database in controller memory to determine if a driver commonly drives more slowly than posted speed limits for a given road.

Another method of displaying traffic on a display within a vehicle may include monitoring a current speed of a vehicle, monitoring external traffic data, determining if a vehicle brake is applied or pressed for at least a predetermined time period, determining that traffic data actually exists ahead of a vehicle for a road upon which the vehicle is traveling, displaying the traffic data (e.g. vehicles in a traffic jam) on a display within the vehicle. The method may further entail determining that the vehicle speed is maintained at a speed less than the posted speed for a predetermined time period, accessing a driver speed database, and determining if a driver speed is historically lower than a posted speed, as explained above. The method of displaying traffic may include determining that a traffic event exists on a road upon which the vehicle is traveling and determining if traffic cameras exist on the road ahead of the vehicle. If a traffic event (e.g. vehicle crash, parade, concert, rain, snow or other climate event that may delay traffic) is detected, then downloading traffic data of the traffic event from a distant computer server may begin.

Continuing, a method of displaying traffic on a display within a vehicle may entail monitoring a current speed of a vehicle, monitoring external traffic data, and monitoring a vehicle brake to determine if the brake is applied for at least a predetermined time period. Moreover, the method may involve determining if the vehicle is a predetermined distance from a traffic signal that the vehicle is approaching, waiting for a predetermined time after confirming that the vehicle is a predetermined distance from a traffic signal that the vehicle is approaching, determining again if the vehicle is a predetermined distance from the traffic signal that the vehicle is approaching, confirming that the vehicle is a predetermined distance from the traffic signal that the vehicle is approaching, determining that a traffic event exists on a road upon which the vehicle is traveling, inquiring if traffic cameras exist on the road upon which the vehicle is traveling, and displaying traffic data on a display within the vehicle that corresponds to the road ahead upon which the vehicle is traveling.

In yet another example, a method of displaying traffic on a display within a vehicle may entail monitoring a current speed of a vehicle, monitoring external traffic data, and monitoring a vehicle brake to determine if the brake is applied for at least a predetermined time period. The method may further involve displaying traffic, determining that the vehicle speed is maintained at a speed less than the posted speed for a predetermined time period, determining that a driver speed is not historically lower than a posted speed, determining that a traffic event exists on a road upon which the vehicle is traveling, inquiring if traffic cameras exist on the road upon which the vehicle is traveling, and displaying traffic data on a display within the vehicle that corresponds to the road ahead upon which the vehicle is traveling.

As another example, a method of displaying traffic on a display within a vehicle may entail monitoring a current speed of a vehicle, monitoring external traffic data, and monitoring a vehicle brake to determine if the brake is applied for at least a predetermined time period, determining that the vehicle speed is maintained at a speed less than the posted speed for a predetermined time period, determining that traffic data exists and displaying the traffic data on a display within the vehicle, determining that a traffic event exists on a road upon which the vehicle is traveling, inquiring if traffic cameras exist on the road upon which the vehicle is traveling, and displaying traffic data on a display within the vehicle that corresponds to the road ahead upon which the vehicle is traveling.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an interior of a vehicle depicting a location of a navigation system;

FIG. 2 is a flowchart depicting a method of controlling a vehicle navigation system in accordance with the present disclosure;

FIG. 3 is a diagram depicting a scenario of a vehicle slowing and stopping as it approaches a traffic signal;

FIG. 4 is a diagram depicting a vehicle outside of a predetermined radius of a traffic signal;

FIG. 5 is a diagram depicting a vehicle inside of a predetermined radius of a traffic signal; and

FIG. 6 is an example display screen shot depicting traffic events, buildings, scale, etc.

Corresponding reference numerals indicate corresponding parts throughout the several views of the drawings.

### DETAILED DESCRIPTION

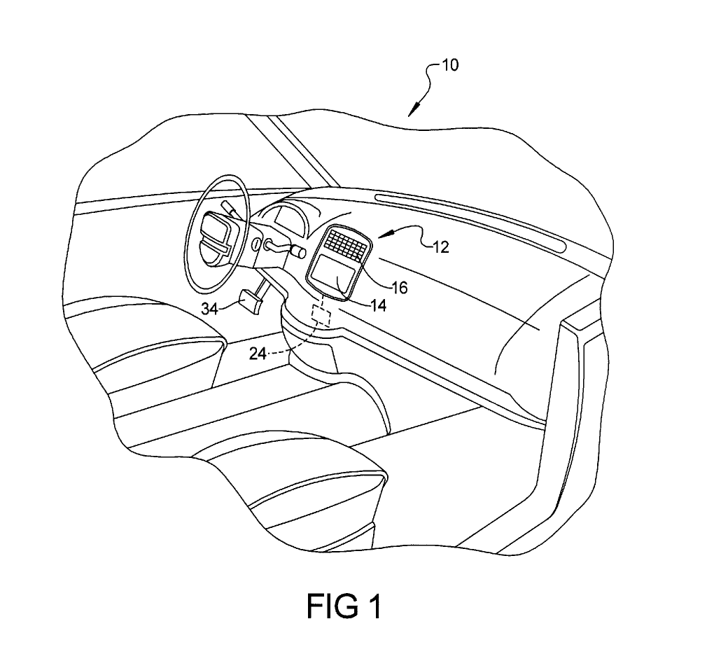

Example embodiments will now be described more fully with reference to FIGS. 1-6 of the accompanying drawings. FIG. 1 depicts an interior view of a vehicle 10 equipped with a factory installed navigation system 12. Navigation system 12 may have a display 14 and buttons 16, which may be used to operate features of navigation system 12. Additionally, display 14 may be a touch-display and may be physically touched with a finger in order to operate a feature of navigation system 12. The touch-display feature of display 14 of navigation system 12 may work in conjunction with operating software of navigation system 12.

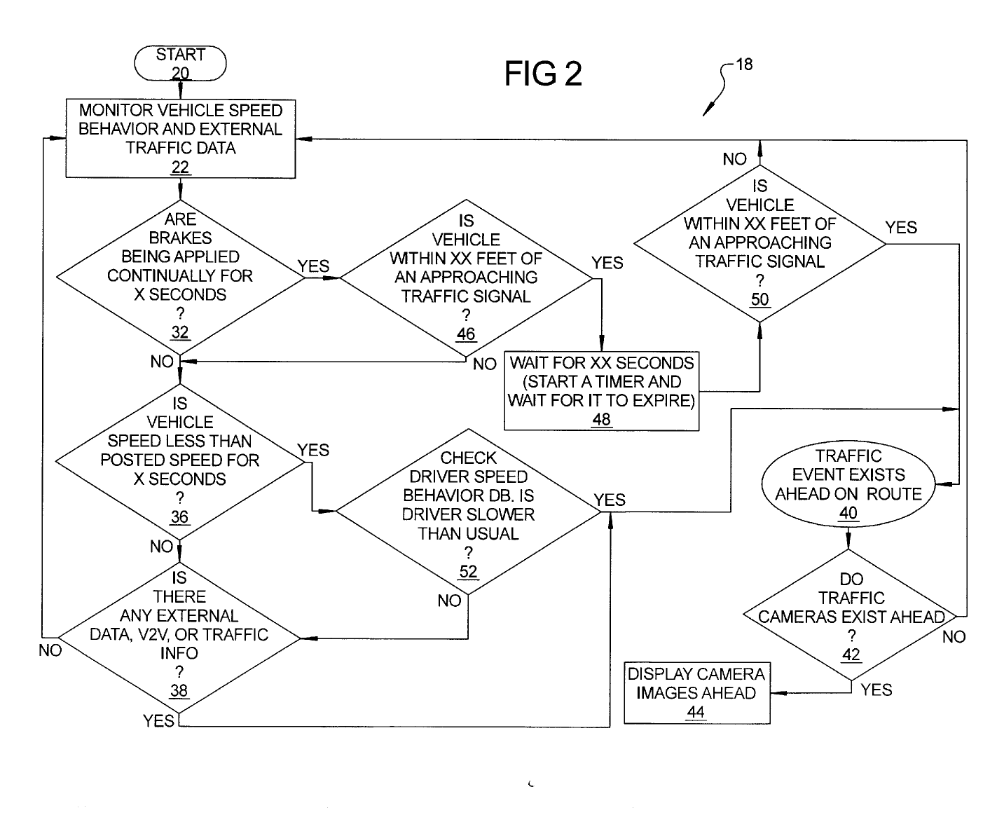

Turning to FIG. 2, flowchart 18 of operating logic of a method of controlling a navigation system such as navigation system 12 will be explained. Subsequent to start of logic at block 20, operating logic 18 proceeds to block 22 where a control module 24 of navigation system 12 may monitor vehicle speed and external traffic data via external servers, for instance. While the present disclosure will be explained using control module 24 which may be directly linked to, and be in communication with, navigation system 12, additional control modules dedicated to specific functions that may supply data to navigation system 12, or perform other functions, may be employed. Continuing with functions associated with block 22, a speed at which a driver of vehicle 10 is traveling may be monitored in conjunction with a type of road upon which vehicle 10 is travelling. For example, speed of vehicle 10 may be monitored by control module 24, which may be directly linked to a vehicle speedometer, engine control module that receives vehicle speed, a transmission control module that receives vehicle speed or other vehicle device that monitors vehicle speed. Regarding categorization of roadways, companies that supply navigation system map data may categorize roads to assist a driver in selecting a roadway to travel and to inform a driver of what types of roadways are available. For instance, a four or six lane limited access highway may be categorized as road type “L₁,” a four lane road that is not limited access, such as in a business district with multiple business having access to the road, may be categorized as road type “L₂,” a two lane road (i.e. one lane in each direction) in a suburban area may be categorized as “L₃,” a residential street may be categorized as “L₄,” and a rural country road may be categorized as “L₅.”

In collecting traffic data or information, various methods or devices may be used. Sensors in a road may communicate traffic conditions based upon how often such sensors sense vehicles driving over such sensors. Sensing a number of vehicles per unit of time greater than a threshold number of vehicles may indicate a traffic event such as a traffic jam, while sensing a number of vehicles per unit of time less than a threshold number of vehicles may not indicate a traffic event such as a traffic jam. As another example, traffic data may be collected by “live field vehicles” which may be driven on prescribed roads to provide traffic reports of traffic conditions. Still yet, probe data from personal navigation devices (“PND”) or cell phones may collect traffic data. Using such traffic data collection methods along with a GPS location will provide location and speed of one or more vehicles back to a central monitoring center, for example, from surrounding communication towers, which may initially receive such traffic data. Central monitoring centers are NavTEQ, TeleAtlas, INRIX, etc., may then broadcast the traffic data on a traffic messaging channel (“TMC”) to end devices (vehicles) using services such as XM or HD radio as a method of transmitting. Such traffic data feeds may be in the form of FM frequencies to HD radio or as a satellite signal from XM, as examples.

Continuing with block 22 and with reference including FIG. 3, as control module 24 monitors vehicle speed behavior of vehicle 10, external traffic data may also be monitored. More specifically, external traffic data may involve control module 24 receiving updates from traffic reports such as traffic data that is imported, downloaded at specific time intervals, or fed via a live information (e.g. video) feed into control module 24. Traffic data may be sourced from a server 26 maintained by a traffic data-collecting company located in an office building 28, for example that is acquired from real-time video camera feeds. Traffic information may be transmitted, wirelessly or with a wire, from a camera or traffic signal 30 (e.g. a traffic light) to server 26, which may then communicate the traffic information into control module 24 of vehicle 10 where it can be displayed on display 14 if so desired by a driver or vehicle occupant. Traffic information may be continuously updated while vehicle 10 is operating.

Continuing with FIG. 2, control logic proceeds to decision block 32 where control module 24 continuously monitors a vehicle braking system, such as by monitoring vehicle brake pedal 34, to determine if brake pedal 34 is being applied or depressed for at least a predetermined amount of time, such as 4 seconds, for example; however, the predetermined time period may be any predetermined time period. If brake pedal 34 is not being depressed for at least a predetermined time period, then the logic proceeds to block 36 where the logic inquires if the vehicle speed is less than the posted speed for a predetermined time period, such as ten seconds. If the response to the inquiry of block 36 is “NO,” then the logic proceeds to block 38 to inquire if there is any external data, vehicle-to-vehicle communication data, or traffic information. If the inquiry block 38 is “NO,” then the logic returns back to block 22 and begins again. However, if the response to the inquiry at block 38 is “YES,” then the logic proceeds to block 40 where the logic determines that a traffic event exists ahead on the roadway upon which vehicle 10 is traveling. The logic then proceeds to block 42 where the logic inquires whether traffic cameras exist forward of vehicle 10. If cameras do exist forward of vehicle 10, then the logic proceeds to block 44 where the control module 24 displays camera images onto display 14 of navigation system 12 within vehicle 10. However, if traffic cameras do not exist forward of vehicle 10, then the logic returns to block 22, as explained above, and the proceeds to block 32. If the inquiry at block 32 is “YES,” in which case brake pedal 34 is being applied continually for at least a predetermined time period, the logic proceeds to block 46 where the logic inquires if vehicle 10 is within a predetermined distance of an approaching traffic signal. If the result of the inquiry at block 46 is “NO,” then the logic proceeds to inquiry block 36; however, if the result of inquiry block 46 is “YES,” then the logic proceeds to block 48 where the logic will wait for a predetermined time period and then the logic will proceed to inquiry block 50 where the logic inquires if the vehicle is within a predetermined distance of an approaching traffic signal. If the inquiry at block 50 is “NO,” then the logic proceeds back to block 22. However, if the inquiry at block 50 is “YES,” then the logic proceeds to block 40 where the logic determines that a traffic event exists ahead on the roadway upon which vehicle 10 is traveling and then proceeds to inquire whether traffic cameras exist ahead at inquiry block 42. Again, if traffic cameras exist, the logic proceeds to block 44 where the navigation system 12 will display camera images ahead of vehicle 10. However, if no cameras exist ahead of vehicle 10, then the logic again returns to block 22.

Regarding inquiry block 36, if the result of the inquiry is “YES,” then the logic proceeds to inquiry block 52 where the logic inquires if the driver is driving slower than usual. Checking whether or not driver is driving slower than usual may be done by control module 24 which checks the driver or vehicle speed and compares it to the driver's speed behavior database.

Turning to FIG. 3, a scenario of vehicle 10 approaching a traffic signal is depicted. More specifically, FIG. 3 depicts vehicle 10 traveling at a normal or constant speed, such as a posted speed limit, when vehicle 10 is outside of a predetermined radius or distance 54 from traffic signal 30. FIG. 3 also depicts vehicle 10 moving within a predetermined radius or distance from traffic signal 30. At the point of moving within the predetermined radius or distance 54 from traffic signal 30, vehicle 10 may begin to move more slowly and decelerate, such for a yellow or red light displayed by traffic signal 30.

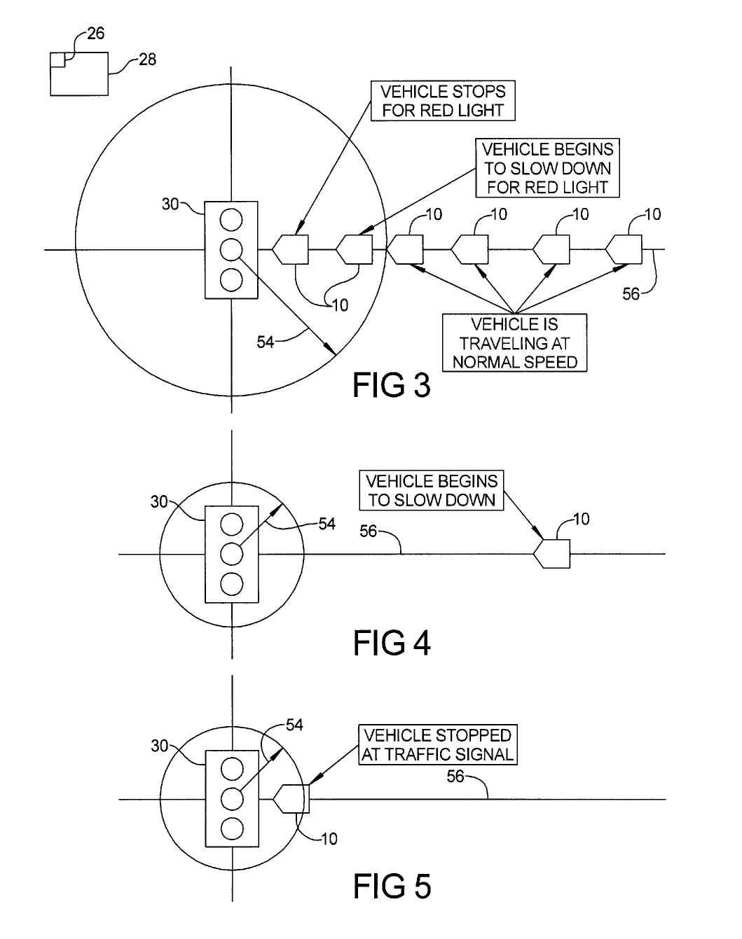

FIG. 4 will be used to further explain a possible change in the scenario of FIG. 3 and depicts vehicle 10 not being within, but rather being outside of, predetermined distance 54 from traffic signal 30. However, even in the position depicted in FIG. 4, vehicle 10 may begin to decelerate and move more slowly. In such a situation, control module 24 may become aware of or become informed of a possible traffic condition by one or more specific “triggers” or an alert. Potential alerts may be vehicle speed or vehicle braking. This means that the traffic condition which exists ahead is not simply a result of the vehicle slowing down for a red light, for example, but a possible traffic incident may exist ahead on the roadway. The control module 24 will understand that the traffic condition that exists ahead is not the result of a traffic signal, such as depicted in FIG. 3, because vehicle 10 will be outside of predetermined distance 54 from traffic signal 30. Vehicle braking as a trigger may be braking time, which may be an interval of time that brake pedal 34 is depressed or applied.

FIG. 5 depicts a scenario in which vehicle 10 is inside a predetermined distance from traffic signal 30, and the logic was informed of a possible traffic condition by one of the triggers, such as vehicle speed or time that vehicle brake pedal 34 is depressed. In the scenario depicted in FIG. 5, it is not known if vehicle 10 is simply stopped for a red light at signal 30, or if some other traffic condition exists. Therefore, the logic monitors the time that vehicle 10 spends or remains inside an enclosed radius 54 from traffic signal 30. If vehicle 10 stays inside such area longer than a predetermined time period (e.g. 120 seconds or 2 minutes), it means that vehicle 10 is not simply waiting for traffic signal 30 to change from red to green, but rather a possible traffic incident may exist ahead on road 56 upon which vehicle 10 is traveling. It is assumed that traffic signals will change from red, meaning stop, to green, meaning go, within 120 seconds or less; however, such predetermined time period of 120 seconds may be changed to any predetermined time period upon which traffic signal 30 may operate.

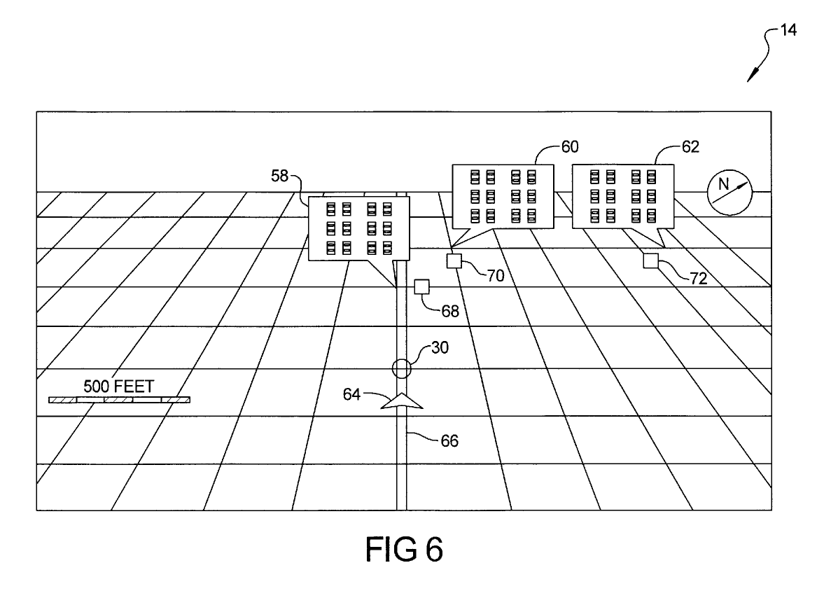

FIG. 6 is an enlarged view of display 14, which may be a navigation system display, depicting various examples of traffic events 58, 60, 62 that may be considered external traffic data. Traffic events may involve a slowing or stopping of vehicles and may be caused by vehicle crashes, parades, concerts, sporting events, rain, snow or other climate event that may delay traffic below a posted speed limit for a given road. Thus, because of inquiries and corresponding results of method steps of flowchart 18 of FIG. 2, a driver in a vehicle at location 64 may view traffic events 58 on display 14 upon applying a brake 34 or by driving below a posted speed limit on road 66. Video of traffic event 58 may be supplied to display 14 by camera 68, which may be located within a viewing distance of traffic event 58. As further examples, camera 70 may depict traffic event 60 and camera 72 may depict traffic event 62 at different locations within a city, etc.

The foregoing description has been provided for purposes of illustration and description. It is not intended to be exhaustive or to limit the invention. Individual features of a particular embodiment and/or method are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. Moreover, the method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A method of displaying traffic of a road on a display within a vehicle, the method comprising:
monitoring a current speed of a vehicle;
monitoring external traffic data;
monitoring a brake of a vehicle;
determining that the brake of the vehicle has not been applied for at least a predetermined time period;
monitoring the speed of a vehicle;
determining if there is any external traffic data regarding the road upon which the vehicle is traveling;
determining that traffic cameras exist ahead on the road; and
displaying, on the display, camera images that the traffic cameras view.

2. The method of displaying traffic according to claim 1, further comprising:
accessing a driver speed database stored in a controller memory within the vehicle and determining that the driver is driving slower than historically recorded relative to a posted speed limit for the road.

3. The method of displaying traffic according to claim 1, wherein displaying traffic data further comprises:
communicating with another vehicle using vehicle to vehicle communication to obtain the traffic data.

4. The method of displaying traffic according to claim 1, further comprising:
determining that a traffic event exists ahead on the road; and
downloading the traffic data from a distant computer server.

5. A method of displaying traffic on a display within a vehicle, comprising:
monitoring a current speed of a vehicle;
monitoring external traffic data;
determining if a vehicle brake is applied for at least a predetermined time period;
determining that traffic data exists and displaying the traffic data on a display within the vehicle; and
displaying traffic data on the display.

6. A method of displaying traffic according to claim 5, wherein before displaying traffic data on the display, the method further comprising:
determining that the vehicle speed is maintained at a speed less than the posted speed for a predetermined time period.

7. A method of displaying traffic according to claim 6, further comprising:
accessing a driver speed database and determining if a driver speed is historically lower than a posted speed.

8. A method of displaying traffic according to claim 5, further comprising:
determining that a traffic event exists on a road upon which the vehicle is traveling.

9. A method of displaying traffic according to claim 8, further comprising:
determining if traffic cameras exist on the road ahead of the vehicle.

10. A method of displaying traffic according to claim 9, further comprising:
downloading traffic data of the traffic event from a distant computer server.

11. A method of displaying traffic according to claim 9, further comprising:
importing the traffic data from another vehicle using vehicle to vehicle communication.

12. A method of displaying traffic according to claim 6, further comprising:
accessing a driver speed database and determining if a driver speed is historically lower than a posted speed.

13. A method of displaying traffic according to claim 12, further comprising:
determining that a driver speed is not historically lower than a posted speed;
determining that a traffic event exists on a road upon which the vehicle is traveling;
downloading traffic data of the traffic event from a distant computer server; and
displaying traffic data on a display within the vehicle.

14. A method of displaying traffic according to claim 13, wherein displaying traffic data further comprises:
importing the traffic data from another vehicle using vehicle to vehicle communication.

15. A method of displaying traffic according to claim 13, wherein displaying traffic data further comprises:
importing the traffic data from a computer server located away from the vehicle.

16. A method of displaying traffic on a display within a vehicle, the method comprising:
monitoring a current speed of a vehicle;
monitoring external traffic data; and
monitoring a vehicle brake to determine if the brake is applied for at least a predetermined time period.

17. The method of displaying traffic according to claim 16, further comprising:
determining if the vehicle is a predetermined distance from a traffic signal that the vehicle is approaching;
waiting for a predetermined time after confirming that the vehicle is a predetermined distance from a traffic signal that the vehicle is approaching;
determining again if the vehicle is a predetermined distance from the traffic signal that the vehicle is approaching;
confirming that the vehicle is a predetermined distance from the traffic signal that the vehicle is approaching;
determining that a traffic event exists on a road upon which the vehicle is traveling;
inquiring if traffic cameras exist on the road upon which the vehicle is traveling; and
displaying traffic data on a display within the vehicle that corresponds to the road ahead upon which the vehicle is traveling.

18. The method of displaying traffic according to claim 16, further comprising:
determining that the vehicle speed is maintained at a speed less than the posted speed for a predetermined time period;
determining that a driver speed is not historically lower than a posted speed;
determining that a traffic event exists on a road upon which the vehicle is traveling;
inquiring if traffic cameras exist on the road upon which the vehicle is traveling; and
displaying traffic data on a display within the vehicle that corresponds to the road ahead upon which the vehicle is traveling.

19. The method of displaying traffic according to claim 16, further comprising:
determining that the vehicle speed is maintained at a speed less than the posted speed for a predetermined time period;
determining that traffic data exists and displaying the traffic data on a display within the vehicle;
determining that a traffic event exists on a road upon which the vehicle is traveling;
inquiring if traffic cameras exist on the road upon which the vehicle is traveling; and
displaying traffic data on a display within the vehicle that corresponds to the road ahead upon which the vehicle is traveling.
